(19) United States
(12) Patent Application Publication
(10) Pub. No.: US 2001/0038876 A1
(43) Pub. Date: Nov. 8, 2001

(54) APPARATUS AND METHOD FOR PRODUCING GRAIN BASED BAKER FOOD PRODUCTS

(75) Inventor: RICHARD M. ANDERSON, WATERVILLE, OH (US)

Correspondence Address: THOMAS E ANDERSON, GIFFORD KRASS GROH SPRINKLE, PATMORE ANDERSON & CITOWSKI, 280 NORTH OLD WOODWARD SUITE 400, BIRMINGHAM, MI, 48009

(73) Assignee: RICHARD M. ANDERSON

(21) Appl. No.: 09/139,298

(22) Filed: Aug. 25, 1998

Related U.S. Application Data
(63) Continuation-in-part of application No. 08/940,107, filed on Sep. 29, 1997, now abandoned.
Application No. 08/940,107 is a continuation-in-part of application No. 08/547,412, filed on Oct. 24, 1995, now abandoned.
Application No. 08/547,412 is a division of application No. 08/140,323, filed on Oct. 22, 1993, now Pat. No. 5,479,850.

(51) Int. Cl. A21D 10/00

(52) U.S. Cl. 426/549

(57) ABSTRACT

An apparatus and method for making grain based baked products according to a predetermined ingredient recipe having a plurality of raw goods supply bins for raw materials. A processing unit selectively introduces predetermined amounts of the grain and the liquid/dry ingredients into a mixing chamber according to the recipe selected. The mixture produced is conveyed through proofing and baking steps. A customer interface permits selection of recipe, amount of product and time of delivery. The customer may place an order from a remote location using a phone or computer to have the baked grain based product produced at a desired time.

This application is a continuation-in-part of application Ser. No. 08/547,412, filed Oct. 24, 1995, which is a divisional of Ser. No. 08/140,323, filed Oct. 22, 1993, now issued as U.S. Pat. No. 5,479,850.

### BACKGROUND OF THE INVENTION

1. Field of the Invention

The present invention relates to machines for producing grain based baked food products and, more particularly, to a machine for producing a variety of baked food products from raw materials with a single apparatus.

2. Description of the Prior Art

Various apparatus for making bread and baked food products are known in the art. Specifically, such apparatus usually include a means for mixing a dough and then for baking the mixture to produce a desired end product.

U.S. Pat. No. 4,938,127, issued to van Lengerich, discloses a device for automatically making a cookie type product. Two extrusion machines are used in series to blend, mix and deliver a partially formed product to the second extrusion device where further ingredients are added. The product is then mixed and delivered to conveyors for transport through a dielectric heating oven.

U.S. Pat. No. 5,016,528, issued to Chen, discloses baking equipment for producing buns, cakes, and the like. The product is produced in individual pan and cover containers in which dough is delivered to the pans and subsequently shaped and treated in successive steps before delivery to an oven for baking.

The shortcomings of the above-described patents include the lack of selection of ingredients which can be provided during the mixing stage in order to formulate different end products. Another drawback is the failure to provide a grinder for grinding whole grain supplied from a supply bin in combination with liquid and dry ingredients in order to produce a wide variety of baked goods.

### SUMMARY OF THE INVENTION

The present invention is an apparatus and method for an automated machine which is capable of producing a variety of dough based products in a location such as a store on demand in response to customer information. The customer may be at a remote location. The dough based product may be produced from a wide selection of both liquid and dry ingredients. A control unit is provided for receiving customer input to select the recipe, the number of units of baked food product, and the time of delivery. The control unit may receive its input directly from the customer by distal input from a phone or remote computer.

The baked food product machine has at least one whole grain storage bin connected to a mixer. A grinder grinds the grain supplied from the storage bin and introduces it into the mixer concurrently with both liquid and other dry ingredients which are separately inputted into the mixer. A processor control unit is connected to the grain supply and both the liquid and dry ingredients and controls the type and amount of ingredients and the amount of grain which is supplied to the mixer. In a preferred embodiment of the invention, the mixer is positioned on top of a scale. The scale determines the quantity of each ingredient which is fed into the mixer by sensing the weight of the applied ingredient. The scale is connected to the ingredient supplies through a processing unit so as to selectively activate and de-activate the ingredient supplies.

In one embodiment an extruder forms the dough into loaves and conveys the dough on a conveyor to a proofing unit which causes the dough to rise. The dough is then transferred to a baking oven and then to cooling racks once the baking step is completed.

In another embodiment of the apparatus of the invention, a plurality of mixers are employed for mixing a number of batches of dough. Each mixer can be supplied with a different set of ingredients so as to customize the type of baked food product to be produced.

A method for making baked food product is also provided which utilizes the steps as substantially described in the above summary of the apparatus of the invention.

### BRIEF DESCRIPTION OF THE DRAWING

Reference is made to the attached drawing of the present invention wherein reference to the numerals in the description refer to like parts throughout the several views and in which:

FIG. 1 is a diagrammatical view of a first preferred embodiment of the baked food product machine of the present invention;

FIG. 2 is a diagrammatical view of a second preferred embodiment of the baked food product machine of the present invention; and

FIG. 3 is a perspective view of a first preferred embodiment of the baked food machine of the present invention.

### DESCRIPTION OF THE PREFERRED EMBODIMENT

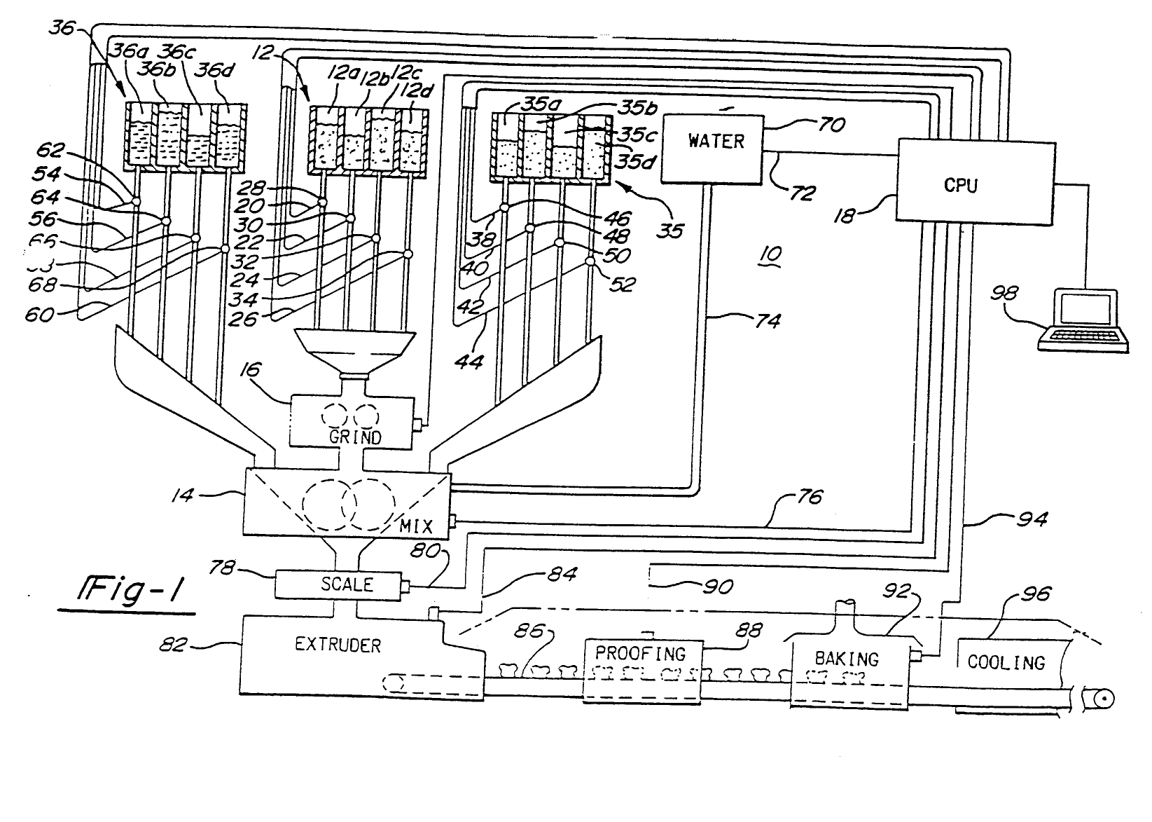

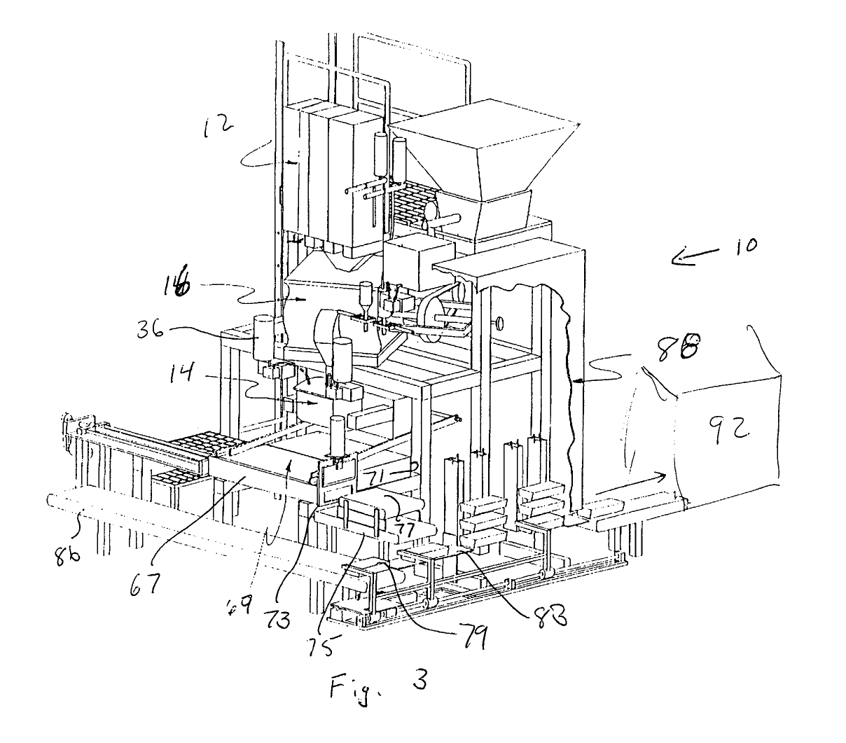

Referring to FIGS. 1 and 3, a first preferred embodiment of the grain based food product machine of the present invention is shown at 10. The machine is suitable for a variety of grain based products such as bread, cookies, rolls and chips. A whole grain storage bin 12 is connected to a mixing chamber 14. A grinder 16 lies intermediate the storage bin 12 and the mixing chamber 14 and grinds to a fine powder the desired quantity of grain supplied from the storage bin 12. The storage bin 12 can be divided into a number of storage bins 12a, 12b, 12c and 12d, each containing a different grain, and one or more of these grains can be selectively introduced into the mixing chamber 14.

A central processing unit 18 is operatively connected to a series of dispensing valves 28, 30, 32 and 34 connected to the grain bins 12a-12d by lines 20, 22, 24, and 26, respectively. The central processing until 18 controls the valves and reciprocating type feeder to determine the amount of grain to be dispensed from each bin 12a-12d according to preprogrammed recipe.

The processing unit 18 is also operatively connected to supplies of both dry ingredients 35 and liquid ingredients 36. The dry and liquid ingredient supplies 35 and 36 can also be divided into a number of different dry ingredient supply bins 35a, 35b, 35c and 35d and liquid ingredient containers 36a, 36b, 36c and 36d and can be selectively inputted into the mixing chamber concurrently with and in the same fashion as the grain from the grain storage bin 12. For example, the dry ingredient storage bins can include ingredients such as salt, flour, sugar, yeast, fruit, poppy seeds, etc. The liquid ingredients may include vanilla extract, water, etc. The bins and containers are formed of clear acrylic and are metered into the mixer with peristaltic pumps. Dry yeast is metered into a heated premix vessel 65 filled with water to rehydrate the yeast before introducing the yeast into the mix. A heated polyethylene water tank maintains a 110 degree water temperature. After the premix vessel discharges into the mixer, makeup water is added, and flows through the premix vessel 65 to purge it.

The processing unit 18 is connected by lines 38, 40, 42 and 44 to the dispensing valves 46, 48, 50 and 52 by lines 38, 40, 42 and 44. The processing unit controls the opening and closing of the dispensing valves to determine the amount of each ingredient which is sent to the mixing chamber from ingredient bins 35a-35d. In the same fashion, the processing unit 18 controls the dispensing of liquid ingredient containers 36a-36d by lines 54, 56, 58 and 60 which deliver signals to control dispensing valves 62, 64, 66 and 68.

A separate water supply 70 is connected to the processing unit 18 by line 72 and may be inputted to the mixing chamber 14 through line 74 in the place of or in combination with the liquid ingredients from containers 36a-36d as may be desired.

The mixing chamber 14 is supported on a scale 78. The scale determines the amount of each ingredient fed into the mixing chamber by sensing the weight of the ingredients. Line 80 connects the scale 78 to the processor 18.

The dough is then thoroughly mixed in the mixing chamber. The processor 18 is connected to the mixer 14 by line 76 and determines the extend to which mixing occurs.

When all ingredients have been combined and the mixing chamber has completed its cycle, the mixer chamber tips forward and gravity drops the dough mass into an extruder 67. An extruder lid 67 descends, compressing the dough mass to a height of 3½″. An extruder backwall 71 advances, compressing the dough mass to a width of 8″. The extruder piston advances to further compress the dough mass into a void-free cubicle. When the dough mass has been compressed to size, a knife blade 73 raises, the piston advances the dough mass approximately 3″, and the knife blade descends and slices off a “brick” of dough. The “brick” gravity drops into a doughroller conveyor 75, and is transported through a doughroller 77 which seals it, forms it into a cylindrical shape, and drops it into a bread pan 79.

The bread pans 79 are automatically shuttled from an empty pan conveyor 86 to a load position 83, from the load position into the proofer, and from the proofer 88 into an exit conveyor. The proofer 88 is a shrouded vertical chamber, maintained at approximately 110 degrees, that handles 30 pans at a time. A batch of 10 pans is shuttled into the proofer 88, which indexes the pans upwards in 5″ increments. The next batch causes another 10 indexes. At the top of the proofer, pans are shifted horizontally and are then indexed downward, the proofer holds three batches, therefore, each 20 minute batch realizes 60 minutes of prooftime.

The proofing unit 88 is connected to the processing unit 18 by line 90 for temperature control in raising the dough. The units of dough are then transported from the proofing unit 88 along the conveyor 86 into a baking oven 92. The oven 92 is connected to the processor 18 by line 94 for temperature control and bakes the dough according to the recipe stored in the processor 18. Once the baking stage is completed, the baked food product is transported to a cooling unit 96 and is loaded, as is conventionally known in the art, onto storage racks or the like.

According to the first preferred embodiment, a single large batch of dough can be generated by the food product machine of the present invention using the processing unit 18 and selecting from a wide variety of whole grains and liquid/dry ingredients. A keyboard control 98 can be inputted to the processor 18 to facilitate the entry of a desired recipe program for generating a batch of dough and the time of delivery.

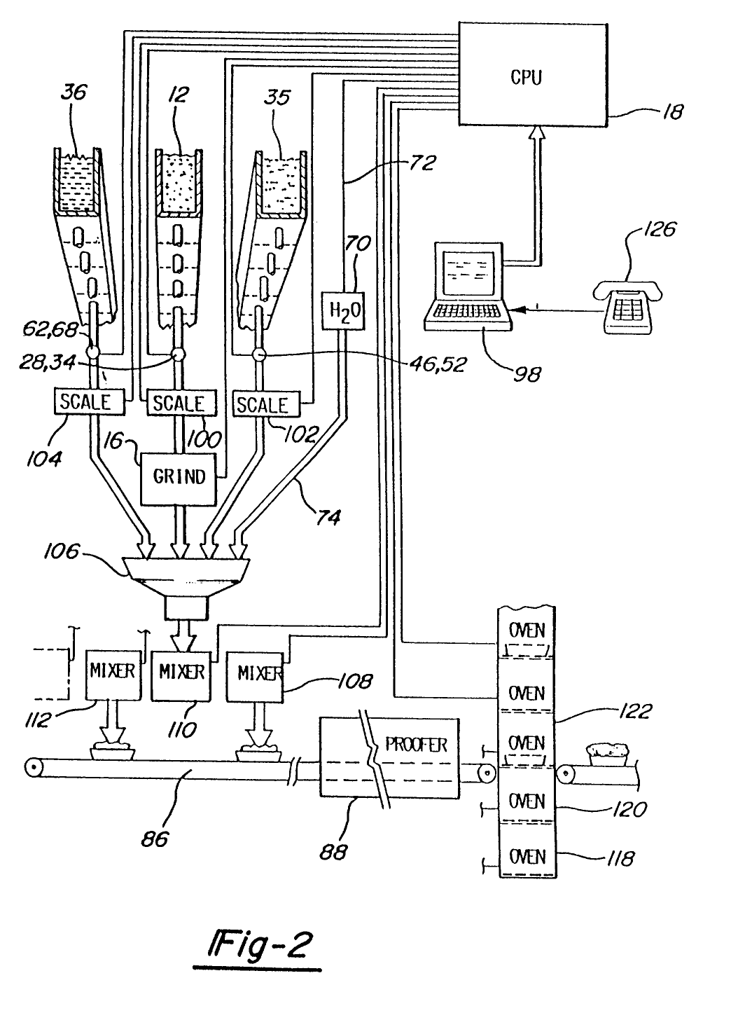

Referring to FIG. 2, there is shown a second preferred embodiment of the present invention. A number of the elements shown in FIG. 2 are common to the disclosure of FIG. 1 and are identified by the same numbers. In the place of the scale 78 of FIG. 1 there are provided separate scales 100, 102 and 104 located beneath the grain storage bin 12 and the dry ingredient and liquid ingredient storage bins 35 and 36, respectively.

The ingredients 12, 35, 36 and the water input 70 are all fed for the dough mixture into a common hopper 106. The common hopper 106 transfers the dough mixture into a sequence of separate mixing chambers such as chambers 108, 110, 112. The provision of a number of separate mixing chambers enables a number of different dough recipes using different combinations of ingredients to be sequentially produced. These recipes may be for bread, cookies, rolls, etc. Each mixing chamber therefore is capable of the production of a loaf of bread or dough based product having characteristics different from any other mixing chamber.

The units of dough are individually mixed and are then deposited onto the conveyor 86. The units of dough are then conveyed into the proofing unit 88 as previously described where the dough is raised. A series of individual baking ovens such as ovens 118, 120, 122 are provided for receiving, respectively, each unit of dough. The ovens then bake the dough as conventionally taught and deposit the baked dough onto a conveyor or cooling racks.

The second embodiment of the invention accordingly enables the grain based food product machine to produce a different kind of dough using different combinations of ingredients, as desired, for each subsequent baked food product produced. This is in contrast to the first embodiment which produces a larger single batch of baked food products using a single recipe of ingredients.

The grain based food product machine of the present invention may be conveniently located in a retail outlet store, such as a supermarket. Customers can come into the store and custom order a baked food product to their own recipe criteria for immediate delivery or delivery at some future time. As a further convenience, distal input such as that indicated by telephone 126 or a home computer could be hooked into the processor 18 and keyboard 98 such that the customer can order the baked food product from his or her home and automatic billing can be incorporated into the control unit 18 for this mode.

The elements of the mixer chamber, extruder, proofing unit, ovens, and CPU can also be integrated into one convenient machine which is fed by the various ingredient inputs.

A process for producing grain based baked food products using the machine of the present invention is also disclosed. The process is fully automated to produce a range of baked food products from supplies of raw materials in a retail store. The process includes storing a number of recipes to produce a variety of baked food products in a process control unit. Next, a customer interface is provided to permit entry of order information, including the quantity of units desired, the recipe, and the time when the goods are to be finished for pickup by the customer. Additionally, the customer may be allowed to enter modifications to the recipe to change the portions of flours or select additives, such as dried fruits or nuts. The process control unit then computes a production time for the mixing, proofing, baking stages and then calculates a start time so that the products are produced and completed just before the customer delivery time. In this way, the customer can select a delivery time at his convenience so that the finished product is just out of the oven when picked up by the customer.

The method then includes initiating a dough making apparatus at the production start time, controlling the dough making apparatus to feed raw ingredients from storage devices and to mix the ingredients in accordance with the recipe selected. As set forth above, the process control unit then directs the apparatus to portion the dough into sections, and proof the sections of dough until the dough rises. Finally, the process control unit then directs the apparatus to deliver the proofed dough by conveyor to one of a number of ovens where it is baked for a predetermined length of time according to the recipe, and, finally, moved by conveyor to a delivery station.

As discussed above, the customer interface can include an automated phone answering device or computer modem which permits the customer to input order information either by personal computer, or by phone from a remote location. The customer can also input directly into the process control unit billing information, such as a credit card number. In this manner, the customer can place an order by phone or by computer days in advance and arrive at the store at the scheduled time to receive a freshly baked product made according to the customer's specifications. As discussed above, the unit can be provided in a single apparatus so that it can be installed in a retail store, such as a grocery store or convenience store.

Accordingly, a single large batch or a number of different individual dough based products may be produced using the process of the present invention.

Having described my invention, many different embodiments will become apparent to one skilled in the art to which the invention pertains without deviating from the scope of the disclosure as set forth in the appended claims.

I claim:

1. An automated process for producing a range of grain based baked food products from a supply of raw materials comprising:
storing a plurality of recipes for producing a plurality of baked food products in a process control unit;
providing a customer interface for inputting a customer order, including entry of quantity of units, a customer recipe or selection of one of said plurality of recipes;
initializing a dough making apparatus and directing the dough making apparatus with said process control unit to feed raw ingredients from storage devices into said mixing apparatus to mix the ingredients according to said recipe selected;
controlling the dough making apparatus with the process control unit to sequentially deliver said mixture of ingredients to a baking station for a predetermined time to produce a finished product; and
delivering said finished product.

2. The automated process of claim 1, wherein said customer interface includes a telephonic interface for receiving customer input from a telephone.

3. The process of claim 1, after said providing step further comprising the step of:
entering an order with a remote computer through said customer interface.

4. The process according to claim 1 further comprising the step of separately delivering water to said raw ingredients during said mixing step.

5. The process according to claim 1 further comprising the step of extruding the mixture of ingredients after mixing the ingredients.

6. The process according to claim 1 further comprising the step proofing said mixture of ingredients before delivering said mixture to said baking station.

7. The process according to claim 1 further comprising the step of grinding said at least one grain drawn from said grain storage bin before mixing said ingredients.

8. The process according to claim 1 further comprising the step of providing a plurality of mixing chambers for separately mixing a like plurality of ingredient mixtures, each of said ingredient mixtures being different from any other of said ingredient mixtures.

9. The process according to claim 8 further comprising the step of providing a plurality of ovens for separately baking each said ingredient mixture drawn from said plurality of mixing chambers.

10. An automated process for producing a range of baked food products from a supply of raw materials in a retail store;
storing a plurality of recipes for producing a plurality of baked food products in a process control unit;
providing a customer interface for inputting a customer order, including entry of quantity of units, delivery time, a customer recipe or selection of one of said plurality of recipes;
computing a production time length and a production start time by subtracting said predetermined production time length from said customer selected delivery time;
initializing a dough making apparatus at said start time and directing the dough making apparatus with said process control unit to feed raw ingredients from storage devices into said mixing apparatus to mix the ingredients according to said recipe selected;
controlling the dough making apparatus with the process control unit to sequentially deliver said mixture of ingredients to a baking station for a predetermined time to produce a finished product; and
delivering said baked product at said predetermined delivery time.

11. The automated process of claim 11, wherein said controlling step further comprises delivering said mixture to a proofing station before delivering the mixture to a baking station.

12. A machine for producing a wide range of baked food products from a supply of raw materials comprising:
a process control unit;
means for inputting a plurality of recipes to said process control unit;
means for selecting a delivery time;
a customer interface with said process control unit for selecting one of said plurality of recipes and said delivery time;
a plurality of storage bins for holding said raw material;
means for feeding one or more of said raw materials from said plurality of bins to a mixing means to form a mixture according to said selected recipe as determined by said process control unit;
means for initiating said means for feeding at a predetermined production time before said delivery time in accordance with said recipe selected;
at least one oven for baking said mixture;
means for delivering said mixture to said at least one oven;
a delivery station for delivering a baked product from said oven at said predetermined delivery time.

13. The machine according to claim 12, wherein said customer interface further comprises a data port adapted to receive input from a remote location.

14. The machine according to claim 12 further comprising a proofing station adapted to receive said mixture from said means for feeding.
